(19) United States
(12) Patent Application Publication
(10) Pub. No.: US 2026/0082397 A1
(43) Pub. Date: Mar. 19, 2026

(54) CONTINUOUS CONTROL FEEDBACK USING FULL DUPLEX FOR CELLULAR VEHICLE-TO-EVERYTHING COMMUNICATIONS

(71) Applicant: QUALCOMM INCORPORATED, San Diego, CA (US)

(72) Inventors: Gideon Shlomo Kutz, Ramat Hasharon (IL); Tal Oved, Modiin (IL); Elad Meir, Ramat Gan (IL); Oren Matsrafi, Yad Modechai (IL)

(21) Appl. No.: 19/102,361

(22) PCT Filed: Sep. 15, 2023
(86) PCT No.: PCT/US2023/032883

§ 371 Date: Feb. 7, 2025

(30) Foreign Application Priority Data
Sep. 16, 2022 (IL) 296559

(51) Int. Cl. H04W 72/25; H04B 7/06; H04L 5/00; H04L 27/26; H04W 4/40

(52) U.S. Cl. CPC H04W 72/25; H04B 7/0639; H04L 5/0005; H04L 27/2678; H04W 4/40

(57) ABSTRACT

Methods, systems, and devices for wireless communications are described. A user equipment (UE) may receive, via a sidelink, a control signal indicating a first set of resource blocks of a channel in a slot for a data message from a second UE. The UE may receive, from the second UE, the data message over the first set of resource blocks in the slot based on the control signal. The UE may transmit, to the second UE via the sidelink, a feedback message over a second set of resource blocks of the channel in the slot. The second set of resource blocks of the channel for feedback messages may correspond to data messages received over the first set of resource blocks of the channel, and the second set of resource blocks may be separated from the first set of resource blocks in frequency.

### CROSS REFERENCE

This application is a 371 National Stage of PCT Application No. PCT/US2023/032883, filed on Sep. 15, 2023, entitled “CONTINUOUS CONTROL FEEDBACK USING FULL DUPLEX FOR CELLULAR VEHICLE-TO-EVERYTHING COMMUNICATIONS,” which claims the benefit of Israel Patent Application No. 296559, filed on Sep. 16, 2022, entitled “CONTINUOUS CONTROL FEEDBACK USING FULL DUPLEX FOR CELLULAR VEHICLE-TO-EVERYTHING COMMUNICATIONS,” and assigned to the assignee hereof. The disclosures of both of which are expressly incorporated by reference herein in their entirety.

### FIELD OF TECHNOLOGY

The following relates to wireless communications, including continuous control feedback using full duplex for cellular vehicle-to-everything (V2X) communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support continuous control feedback using full duplex for cellular vehicle-to-everything (V2X) communications. For example, the described techniques provide for fast or continuous feedback in a V2X system using full duplex operation. A sidelink channel may include multiple subchannels for data signaling and multiple resources (e.g., resource blocks) for control signaling. A first UE may receive a data message from a second UE on a first set of resource blocks for data signaling while the first UE transmits a control message (e.g., a feedback message) to the second UE on a second set of resource blocks for control signaling. For example, the first UE may both receive a data message while concurrently transmitting a feedback message in response to a previous data message. The feedback message may include channel state feedback, such as channel quality information, a precoder matrix indication, and rank indicator updates, which may enable tighter link adaptation and precoding in a V2X system. Additionally, or alternatively, the feedback message may include acknowledgment feedback.

To support continuous feedback using full duplex operation, the wireless communications system may support data and control allocation pairs to allocate resources for data message reception and resources for control message transmission. For example, continuous feedback control resource allocation may include, in addition to a data allocation, an additional resource block for control signaling. In some examples, data resources and control resources may be paired, such as to support a minimal gap in frequency between the data resources and control resources, reducing interference between transmission and reception using the resources. In some examples, the data and control resource allocation pairs may be configured per resource pool. Additionally, or alternatively, a data and control resource allocation pair may be determined dynamically and indicated in sidelink control information. Some example resource allocation schemes for data and control resource allocation pairs are described herein.

A method for wireless communications at a first UE is described. The method may include receiving, via a sidelink, a control signal indicating a first set of resource blocks of a channel in a slot for a data message from a second UE, receiving, from the second UE via the sidelink, the data message over the first set of resource blocks in the slot based on the control signal, and transmitting, to the second UE via the sidelink, a feedback message over a second set of resource blocks of the channel in the slot, the second set of resource blocks of the channel for feedback messages corresponding to data messages received over the first set of resource blocks of the channel, and the second set of resource blocks separated from the first set of resource blocks in frequency by one or more resource blocks.

An apparatus for wireless communications at a first UE is described. The apparatus may include a processor, memory coupled with the processor, and instructions stored in the memory. The instructions may be executable by the processor to cause the apparatus to receive, via a sidelink, a control signal indicating a first set of resource blocks of a channel in a slot for a data message from a second UE, receive, from the second UE via the sidelink, the data message over the first set of resource blocks in the slot based on the control signal, and transmit, to the second UE via the sidelink, a feedback message over a second set of resource blocks of the channel in the slot, the second set of resource blocks of the channel for feedback messages corresponding to data messages received over the first set of resource blocks of the channel, and the second set of resource blocks separated from the first set of resource blocks in frequency by one or more resource blocks.

Another apparatus for wireless communications at a first UE is described. The apparatus may include means for receiving, via a sidelink, a control signal indicating a first set of resource blocks of a channel in a slot for a data message from a second UE, means for receiving, from the second UE via the sidelink, the data message over the first set of resource blocks in the slot based on the control signal, and means for transmitting, to the second UE via the sidelink, a feedback message over a second set of resource blocks of the channel in the slot, the second set of resource blocks of the channel for feedback messages corresponding to data messages received over the first set of resource blocks of the channel, and the second set of resource blocks separated from the first set of resource blocks in frequency by one or more resource blocks.

A non-transitory computer-readable medium storing code for wireless communications at a first UE is described. The code may include instructions executable by a processor to receive, via a sidelink, a control signal indicating a first set of resource blocks of a channel in a slot for a data message from a second UE, receive, from the second UE via the sidelink, the data message over the first set of resource blocks in the slot based on the control signal, and transmit, to the second UE via the sidelink, a feedback message over a second set of resource blocks of the channel in the slot, the second set of resource blocks of the channel for feedback messages corresponding to data messages received over the first set of resource blocks of the channel, and the second set of resource blocks separated from the first set of resource blocks in frequency by one or more resource blocks.

Some examples of the method, apparatuses, and non-transitory computer-readable medium described herein may further include operations, features, means, or instructions for receiving control signaling indicating an association between resource blocks of a first pool of resources for the data messages and resource blocks of a second pool of resources for the feedback messages.

In some examples of the method, apparatuses, and non-transitory computer-readable medium described herein, receiving the control signal may include operations, features, means, or instructions for receiving a first indication of the first set of resource blocks from the first pool of resources and a second indication of the second set of resource blocks from the second pool of resources.

In some examples of the method, apparatuses, and non-transitory computer-readable medium described herein, receiving the control signal may include operations, features, means, or instructions for receiving an indication of the first set of resource blocks from the first pool of resources, where the second set of resource blocks may be identified based on a correspondence between the first set of resource blocks and the second set of resource blocks.

In some examples of the method, apparatuses, and non-transitory computer-readable medium described herein, receiving the control signal may include operations, features, means, or instructions for receiving an indication of the second set of resource blocks of the channel for transmission of the feedback message.

In some examples of the method, apparatuses, and non-transitory computer-readable medium described herein, the second set of resource blocks may be based on a resource occupancy of the channel.

In some examples of the method, apparatuses, and non-transitory computer-readable medium described herein, transmitting the feedback message may include operations, features, means, or instructions for transmitting the feedback message concurrent with receiving the data message.

In some examples of the method, apparatuses, and non-transitory computer-readable medium described herein, transmitting the feedback message may include operations, features, means, or instructions for transmitting a precoding matrix indicator, acknowledgement feedback, channel coding information, or any combination thereof.

In some examples of the method, apparatuses, and non-transitory computer-readable medium described herein, transmitting the feedback message may include operations, features, means, or instructions for transmit the feedback message using an extended cyclic prefix for the feedback message.

In some examples of the method, apparatuses, and non-transitory computer-readable medium described herein, the second set of resource blocks may be multiplexed, according to a cyclic shift, on a same set of time-frequency resources with a third set of resource blocks for feedback messages transmitted by the second UE or a third UE.

In some examples of the method, apparatuses, and non-transitory computer-readable medium described herein, transmitting the feedback message may include operations, features, means, or instructions for transmitting the feedback message indicating feedback for a data message received from the second UE in a previous slot.

In some examples of the method, apparatuses, and non-transitory computer-readable medium described herein, the first set of resource blocks may be one of a first set of multiple sets of resource blocks for a group of UEs in a first portion of the channel in the slot, and the second set of resource blocks may be one of a second set of multiple sets of resource blocks for the group of UEs in a corresponding second portion of the channel in the slot.

In some examples of the method, apparatuses, and non-transitory computer-readable medium described herein, the first set of resource blocks may be one of a first set of multiple sets of resource blocks for a group of UEs in the channel in the slot, and the second set of resource blocks may be one of a second set of multiple sets of resource blocks for the group of UEs in the channel in the slot and sets of resource blocks of the second set of multiple sets of resource blocks may be interleaved with sets of resource blocks of the first set of multiple sets of resource blocks.

In some examples of the method, apparatuses, and non-transitory computer-readable medium described herein, the first set of resource blocks may be one of a first set of multiple sets of resource blocks for a group of UEs in the channel in the slot, and the second set of resource blocks may be one of a second set of multiple sets of resource blocks for the group of UEs in the channel in the slot and a first portion of sets of resource blocks of the second set of multiple sets of resource blocks may be adjacent a first edge of the channel, and a second portion of sets of resource blocks of the second set of multiple sets of resource blocks may be adjacent a second edge of the channel.

In some examples of the method, apparatuses, and non-transitory computer-readable medium described herein, the channel may be a radio frequency spectrum band for V2X communications.

A method for wireless communications at a second UE is described. The method may include transmitting, to a first UE via a sidelink, a control signal indicating a first set of resource blocks of a channel in a slot for a data message to the first UE, transmitting, to the first UE via the sidelink, the data message over the first set of resource blocks in the slot based on the control signal, and receiving, from the first UE via the sidelink, a feedback message over a second set of resource blocks of the channel in the slot, the second set of resource blocks of the channel for feedback messages corresponding to data messages transmitted over the first set of resource blocks of the channel, and the second set of resource blocks separated from the first set of resource blocks in frequency by one or more resource blocks.

An apparatus for wireless communications at a second UE is described. The apparatus may include a processor, memory coupled with the processor, and instructions stored in the memory. The instructions may be executable by the processor to cause the apparatus to transmit, to a first UE via a sidelink, a control signal indicating a first set of resource blocks of a channel in a slot for a data message to the first UE, transmit, to the first UE via the sidelink, the data message over the first set of resource blocks in the slot based on the control signal, and receive, from the first UE via the sidelink, a feedback message over a second set of resource blocks of the channel in the slot, the second set of resource blocks of the channel for feedback messages corresponding to data messages transmitted over the first set of resource blocks of the channel, and the second set of resource blocks separated from the first set of resource blocks in frequency by one or more resource blocks.

Another apparatus for wireless communications at a second UE is described. The apparatus may include means for transmitting, to a first UE via a sidelink, a control signal indicating a first set of resource blocks of a channel in a slot for a data message to the first UE, means for transmitting, to the first UE via the sidelink, the data message over the first set of resource blocks in the slot based on the control signal, and means for receiving, from the first UE via the sidelink, a feedback message over a second set of resource blocks of the channel in the slot, the second set of resource blocks of the channel for feedback messages corresponding to data messages transmitted over the first set of resource blocks of the channel, and the second set of resource blocks separated from the first set of resource blocks in frequency by one or more resource blocks.

A non-transitory computer-readable medium storing code for wireless communications at a second UE is described. The code may include instructions executable by a processor to transmit, to a first UE via a sidelink, a control signal indicating a first set of resource blocks of a channel in a slot for a data message to the first UE, transmit, to the first UE via the sidelink, the data message over the first set of resource blocks in the slot based on the control signal, and receive, from the first UE via the sidelink, a feedback message over a second set of resource blocks of the channel in the slot, the second set of resource blocks of the channel for feedback messages corresponding to data messages transmitted over the first set of resource blocks of the channel, and the second set of resource blocks separated from the first set of resource blocks in frequency by one or more resource blocks.

Some examples of the method, apparatuses, and non-transitory computer-readable medium described herein may further include operations, features, means, or instructions for receiving control signaling indicating an association between resource blocks of a first pool of resources for the data messages and resource blocks of a second pool of resources for the feedback messages.

In some examples of the method, apparatuses, and non-transitory computer-readable medium described herein, transmitting the control signal may include operations, features, means, or instructions for transmitting a first indication of the first set of resource blocks from the first pool of resources and a second indication of the second set of resource blocks from the second pool of resources.

In some examples of the method, apparatuses, and non-transitory computer-readable medium described herein, transmitting the control signal may include operations, features, means, or instructions for transmitting an indication of the first set of resource blocks from the first pool of resources, where the second set of resource blocks may be identified based on a correspondence between the first set of resource blocks and the second set of resource blocks.

In some examples of the method, apparatuses, and non-transitory computer-readable medium described herein, transmitting the control signal may include operations, features, means, or instructions for transmitting an indication of the second set of resource blocks of the channel for transmission of the feedback message.

In some examples of the method, apparatuses, and non-transitory computer-readable medium described herein, the second set of resource blocks may be based on a resource occupancy of the channel.

In some examples of the method, apparatuses, and non-transitory computer-readable medium described herein, receiving the feedback message may include operations, features, means, or instructions for receiving the feedback message concurrent with transmitting the data message.

In some examples of the method, apparatuses, and non-transitory computer-readable medium described herein, receiving the feedback message may include operations, features, means, or instructions for receiving the feedback message including a precoding matrix indicator, acknowledgement feedback, an extended cyclic prefix, channel coding information, or any combination thereof.

In some examples of the method, apparatuses, and non-transitory computer-readable medium described herein, the second set of resource blocks may be multiplexed, according to a cyclic shift, on a same set of time-frequency resources with a third set of resource blocks for feedback messages transmitted by the second UE or a third UE.

In some examples of the method, apparatuses, and non-transitory computer-readable medium described herein, receiving the feedback message may include operations, features, means, or instructions for receiving the feedback message indicating feedback for a data message transmitted to the first UE in a previous slot.

Some examples of the method, apparatuses, and non-transitory computer-readable medium described herein may further include operations, features, means, or instructions for updating a precoder for transmission to the first UE based on the feedback message.

In some examples of the method, apparatuses, and non-transitory computer-readable medium described herein, the first set of resource blocks may be one of a first set of multiple sets of resource blocks for a group of UEs in a first portion of the channel in the slot, and the second set of resource blocks may be one of a second set of multiple sets of resource blocks for the group of UEs in a corresponding second portion of the channel in the slot.

In some examples of the method, apparatuses, and non-transitory computer-readable medium described herein, the first set of resource blocks may be one of a first set of multiple sets of resource blocks for a group of UEs in the channel in the slot, and the second set of resource blocks may be one of a second set of multiple sets of resource blocks for the group of UEs in the channel in the slot and sets of resource blocks of the second set of multiple sets of resource blocks may be interleaved with sets of resource blocks of the first set of multiple sets of resource blocks.

In some examples of the method, apparatuses, and non-transitory computer-readable medium described herein, the first set of resource blocks may be one of a first set of multiple sets of resource blocks for a group of UEs in the channel in the slot, and the second set of resource blocks may be one of a second set of multiple sets of resource blocks for the group of UEs in the channel in the slot and a first portion of sets of resource blocks of the second set of multiple sets of resource blocks may be adjacent a first edge of the channel, and a second portion of sets of resource blocks of the second set of multiple sets of resource blocks may be adjacent a second edge of the channel.

### BRIEF DESCRIPTION OF THE DRAWINGS

FIG. 1 illustrates an example of a wireless communications system that supports continuous control feedback using full duplex for cellular vehicle-to-everything (V2X) communications in accordance with one or more aspects of the present disclosure.

FIG. 2 illustrates an example of a wireless communications system that supports continuous control feedback using full duplex for cellular V2X communications in accordance with one or more aspects of the present disclosure.

FIG. 3 illustrates examples of resource allocation schemes that support continuous control feedback using full duplex for cellular V2X communications in accordance with one or more aspects of the present disclosure.

FIG. 4 illustrates an example of a process flow that supports continuous control feedback using full duplex for cellular V2X communications in accordance with one or more aspects of the present disclosure.

FIGS. 5 and 6 show block diagrams of devices that support continuous control feedback using full duplex for cellular V2X communications in accordance with one or more aspects of the present disclosure.

FIG. 7 shows a block diagram of a communications manager that supports continuous control feedback using full duplex for cellular V2X communications in accordance with one or more aspects of the present disclosure.

FIG. 8 shows a diagram of a system including a device that supports continuous control feedback using full duplex for cellular V2X communications in accordance with one or more aspects of the present disclosure.

FIGS. 9 through 11 show flowcharts illustrating methods that support continuous control feedback using full duplex for cellular V2X communications in accordance with one or more aspects of the present disclosure.

### DETAILED DESCRIPTION

A wireless communications system may support sidelink communications between two devices, such as two user equipment (UE). In some examples, sidelink communications systems may be implemented in vehicle-to-everything (V2X) communications systems, where vehicles, or vehicle UEs, may communicate via a sidelink channel. Some V2X systems may support high data rates, which may correspond to significant overhead and load for the system. Additionally, some V2X systems may not support closed loop precoding, as high velocities of the vehicle UEs may result in prohibitive overhead to provide frequent feedback for precoder updates. However, precoding and precoding feedback may increase channel capacity and channel gain.

Techniques described herein support fast precoding feedback in a wireless communications system by implementing continuous feedback through full duplex operation. A sidelink channel may include multiple subchannels for data signaling and multiple resources (e.g., resource blocks) for control signaling. A first UE may receive a data message from a second UE on a first set of resource blocks for data signaling while the first UE transmits a control message (e.g., a feedback message) to the second UE on a second set of resource blocks for control signaling. For example, the first UE may both receive a data message while concurrently transmitting a feedback message in response to a previous data message. The feedback message may include channel state feedback, such as channel quality information, a precoder matrix indication, and rank indicator updates, which may enable tighter link adaptation and precoding in a V2X system. Additionally, or alternatively, the feedback message may include acknowledgment feedback.

To support continuous feedback using full duplex operation, the wireless communications system may support data and control allocation pairs to allocate resources for data message reception and resources for control message transmission. For example, continuous feedback control resource allocation may include, in addition to a data allocation, an additional resource block for control signaling. In some examples, data resources and control resources may be paired, such as to support a minimal gap in frequency between the data resources and control resources, reducing interference between transmission and reception using the resources. In some examples, the data and control resource allocation pairs may be configured per resource pool. Additionally, or alternatively, a data and control resource allocation pair may be determined dynamically and indicated in sidelink control information. Some example resource allocation schemes for data and control resource allocation pairs are described herein.

Aspects of the disclosure are initially described in the context of wireless communications systems. Aspects of the disclosure are further illustrated by and described with reference to apparatus diagrams, system diagrams, and flowcharts that relate to continuous control feedback using full duplex for cellular V2X communications.

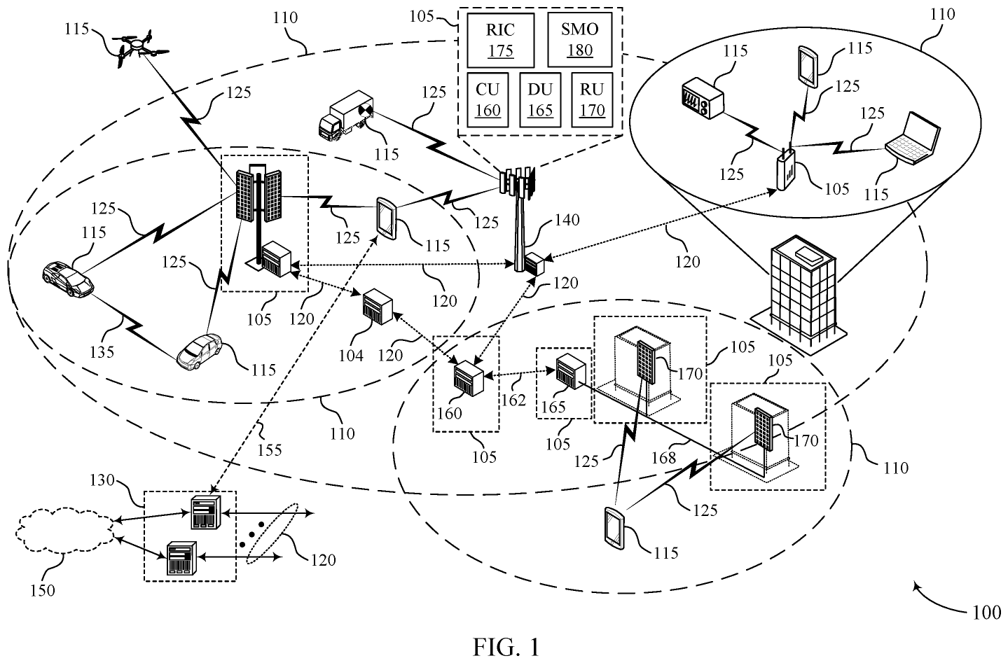

FIG. 1 illustrates an example of a wireless communications system 100 that supports continuous control feedback using full duplex for cellular V2X communications in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUS 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support continuous control feedback using full duplex for cellular V2X communications as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using V2X communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The wireless communications system 100 may support V2X communications, such as cellular V2X communications. Some cellular V2X applications may use a high data rate, such as 40 megabytes per second. This may have significant load requirements for a system supporting multiple cellular V2X sessions. These high data rate applications may correspond to a unicast mode or use unicast signaling.

Some cellular V2X systems may not support closed loop precoding due to high velocities of UEs 115 (e.g., vehicular UEs 115) in the cellular V2X systems. The high velocities of the UEs 115 may lead to frequent directional changes or precoding changes. As such, precoding in these systems may use frequent feedback to update the precoder. For example, in high speed scenarios, a precoder for directional beamforming may be updated at least once per slot. In some examples, cellular V2X systems may use two antennas, which may limit precoding options using a small amount of control signaling to estimate the precoder. However, precoding may still lead to increased gain and channel capacity.

Some systems may support full duplex operation, where a device both transmits and receives simultaneously. For example, a wireless communications system may support continuous feedback through full duplex operation over a Uu link. these systems may use a small quantity of resource blocks (e.g., in the middle of a downlink allocation) to provide continuous uplink control information. These techniques may use full duplex operation. The downlink resources and uplink resources are scheduled to overlap in time, and though the downlink resources and the uplink resources are not in a same sub-carrier, the resources may be in a same band. Therefore, there may be interference between uplink control information transmission to downlink data reception. The downlink bandwidth may be greater than the uplink bandwidth, resulting in significant processing gain to achieve full duplex operation.

In some examples, a system may support full duplex operation at a UE 115. However, uplink transmission from the UE 115 may interfere with downlink reception at the UE 115. For example, the uplink transmission may be received with higher power, as the downlink signaling may saturate the receive components at the UE. Additionally, or alternatively, uplink transmission may leak to the downlink in-band allocation. For example, there may be a loss of orthogonality of downlink and uplink transmission due to the downlink and uplink time difference due to the timing advance. Additionally, or alternatively, spectral broadening due to deterministic effects (e.g., non-linearity effects of a power amplifier) or noise-like effects (e.g., phase noise) may result in the uplink transmission leaking to the downlink in-band allocation.

In some examples, full duplex may be supported at the UE 115 by mitigating uplink-to-downlink interference. For example, the full duplex operation may include a configurable guard band as described by techniques herein. In some examples, full duplex operation may include transmit-receive separation, such as by using over-the-air separating by using beamformed communications. In some examples, full duplex operation described herein may prevent analog cancellation. For example, leakage of the transmit signal to the receive side with negative phase may add destructively. In some examples, full duplex operation may support digital residual cancellation, where residual interference is cancelled digitally at the UE 115.

The wireless communications system 100 may support mitigating uplink-to-downlink loss of orthogonality by using dedicated tones. Since the uplink-to-downlink timing mismatch is known at a UE 115, the UE 115 may calculate cancellation tones to suppress the interference. Active tone cancellation may provide flexibility in a quantity of tones used for signal shaping but may offer limited cancellation. By using cyclic extension of the symbols, the uplink-to-downlink loss may be prevented. An amount of spectral broadening may be based on UE characteristics, such as non-linearity, phase noise, and self-interference cancellation capabilities. Therefore, a size of guard band may be UE-specific. The wireless communications system 100 may support for a network entity 105 to be aware of UE-specific guard bands to optimize usage of frequency resources.

The wireless communications system 100 may support techniques for fast and continuous control information transmission. For example, the wireless communications system 100 may support techniques or continuous control feedback in a cellular V2X system using full duplex operation. In a V2X system, continuous control feedback may provide fast and continuous channel state feedback reporting. The continuous channel state feedback reporting may enable tighter link adaptation, including channel quality indicator updates or rank updates. Continuous control feedback may support precoding in a V2X system by providing fast PMI updates to accommodate precoding in high speed scenarios.

Additionally, or alternatively, continuous control feedback may support HARQ feedback latency reduction. For example, acknowledgment feedback may be mapped to the continuous control feedback. With HARQ feedback latency reduction, the V2X system may support low latency applications, such as applications using URLLC. Additionally reducing HARQ feedback latency may enable a UE 115 to use a decreased quantity of HARQ processes, saving memory and reducing complexity at the UE 115. Additionally, fast feedback may prevent collisions on the sidelink channel, as a UE 115 that transmits may also receive control information, and monitoring for the control information may be used to detect colliding allocations by estimating interference to the control feedback.

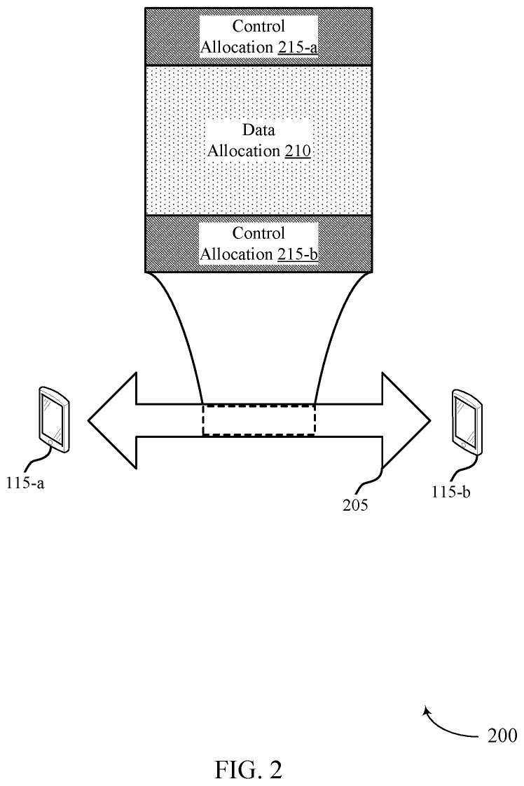

FIG. 2 illustrates an example of a wireless communications system 200 that supports continuous control feedback using full duplex for cellular V2X communications in accordance with one or more aspects of the present disclosure. The wireless communications system may include a UE 115-a and a UE 115-b, which may be examples of UEs 115 as described with reference to FIG. 1. In some examples, the wireless communications system 200 may be an example of a V2X wireless communications system. The UE 115-a and the UE 115-b may be examples of vehicle UEs 115.

The UE 115-a and the UE 115-b may communicate over a sidelink channel 205. The UE 115-a or the UE 115-b, or both, may support full duplex operation, such as to support fast or continuous control feedback. For example, the sidelink channel 205 may include a data allocation 210 with multiple subchannels for data signaling and a control allocation 215 with one or more resource blocks for control signaling. The data allocation 210 may overlap with the control allocation 215 in time. For example, the UE 115-a may receive a data message from the UE 115-b via one or more resource blocks of the data allocation 210 while transmitting a control message to the UE 115-b via one or more resource blocks of the control allocation 215-b.

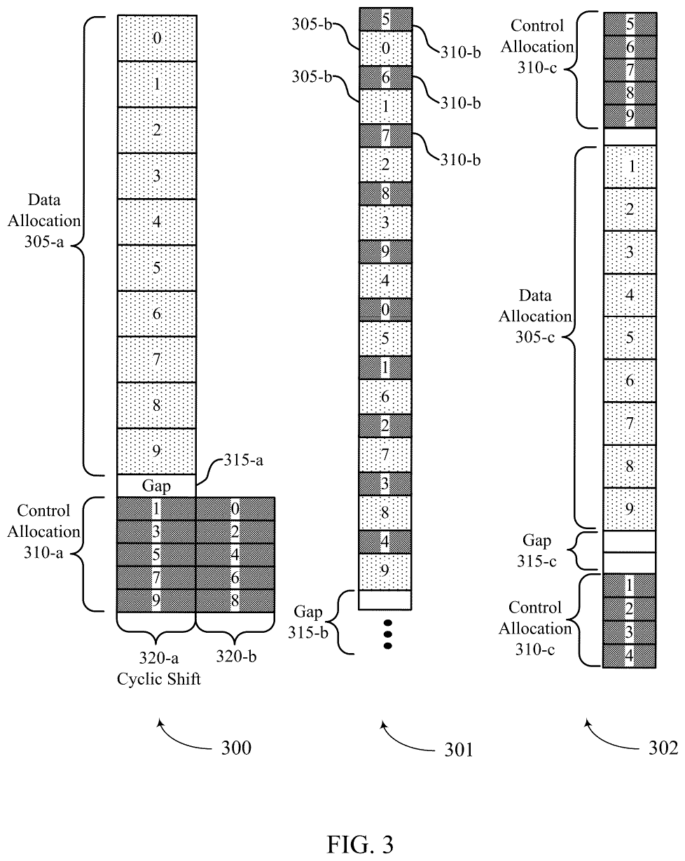

The data allocation 210 and the control allocation 215 may be multiplexed according to one or more possible configurations. For example, resource blocks of the data allocation may be grouped together in the sidelink channel 205 or dispersed. In some examples, the control allocation 215 may be split into multiple separate resource groups, such as a control allocation 215-a and a control allocation 215-b. Different allocation schemes for the data allocation 210 and the control allocation 215 are described in more detail with reference to FIG. 3.

The wireless communications system 200 may support allocating data resources and control resources on the sidelink channel 205 as pairs. For example, a data resource from the data allocation 210 may be paired with a control resource from the control allocation 215. When a UE 115 is assigned the data resource to receive a data message, the UE 115 may also be assigned the control resource to transmit a control message using full duplex operation. For example, the UE 115 may receive the data message via the data resource while transmitting the control message via the control resource. The data and control allocation pairs may be used for fast and continuous control feedback.

For example, the UE 115-a may receive control signaling scheduling the UE 115-a to receive a data message from the UE 115-b on a data resource of the data allocation 210. The data resource may be paired with a control resource of the control allocation 215. Therefore, in addition to the data resource, the UE 115-a may be allocated the control resource (e.g., one or more additional resource blocks) to transmit feedback control information in the opposite direction (e.g., to the UE 115-b). In some examples, a data resource and a control resource which are paired together for continuous feedback may be referred to as an allocation pair or a data and control allocation pair.

There may be multiple configurations for allocating the control resource of a data and control allocation pair. For example, some V2X systems use a channel with residual, or unused, resource blocks. For example, some 40 MHz channels may include 106 resource blocks, including 10 sub-channels consisting of 10 resource blocks each. These channels may include 6 resource blocks which are, in these systems, unused or residual. In some examples, the wireless communications systems may use the remaining resource blocks of the sidelink channel (e.g., which do not correspond to data subchannels of the data allocation 210) as the control allocation 215. Other techniques are described in more detail with reference to FIG. 3.

The data and control allocation pairs may be configured to have a minimal gap between the data resource and the control resource of a pair. For example, a control resource of an allocation pair may be configured to be separated from a data resource of the allocation pair by at least a minimum quantity of resource blocks. By configuring the allocation pairs with a gap in frequency between the data resources and the control resources, a UE 115 transmitting the uplink message may experience mitigated interference between transmission and reception, simplifying the full duplex operation.

In some examples, the data and control allocation pairs may be configured per resource pool. For example, the allocation pairs may be configured per transmit and receive resource pool. In some examples, the UE 115-a or the UE 115-b, or both, may receive control signaling (e.g., RRC signaling) configuring the data and control allocation pairs. Therefore, when the UE 115-a is scheduled to receive a data message on a data resource, the UE 115-b may determine a corresponding or paired control resource based on the control signaling configuring the allocation pairs.

Additionally, or alternatively, the data and control pairing may be determined and indicated dynamically. For example, the UE 115-b may transmit sidelink control information to the UE 115-a, indicating the data resource or the control resource, or both. In some cases, dynamic indication of a resource pair may be based on resource occupancy conditions. For example, the UE 115-b may select the data resource or the control resource, or both, based on a channel occupancy of the sidelink channel 205, the data allocation 210, or the control allocation 215, or any combination thereof.

In some examples, the data and control allocation pairs may be selected based on a semi-static configuration and a dynamic selection. For example, a resource pool may include (e.g., be configured with) resources for data signaling and resources for control signaling, and the UE 115-b may dynamically select a data resource from the data resources and a control resource from the control resources. In some examples, the sidelink channel 205 may be configured with multiple different data and control allocation pairs, and the UE 115-b may indicate one pair from the multiple pairs via sidelink control information. Additionally, or alternatively, a network entity 105 may transmit control signaling to the UE 115 indicating multiple data and control resource allocation pair configurations, and the network entity 105 may transmit signaling to the UEs 115 indicating a configuration from the multiple data and control resource allocation pair configurations.

In some cases, data and control resource allocation pairs may be fixed. For example, a UE 115 that uses a first subchannel for data may use a corresponding resource block for feedback. For example, the UE 115-a may be assigned or scheduled for data communication on a first subchannel of the data allocation 210, and the UE 115-a may transmit an associated control message on a control resource block of the control allocation 215 based on the pairing. In this example, channel sensing may be performed on the data resource (e.g., only on the data resource). For example, the UE 115-b may perform channel sensing on subchannels in the data allocation 210 and schedule the UE 115-a to receive a data message on a data subchannel which has low channel occupancy (e.g., few other UEs 115 are using that data subchannel). In another example, the UE 115 may perform sensing jointly on the data resource and the control resource (e.g., tones corresponding to the data resource and the control resource).

In some cases, the data and control resource allocation pairs may be dynamic. For example, a pairing between a data resource (e.g., a data subchannel) and a control resource (e.g., a control resource block) may be determined per allocation. For example, the UE 115-b may perform sensing on data subchannels and control resource blocks independently, and the UE 115-b may select each separately. For example, the UE 115-b may select a data subchannel based on the sensing window and randomly select a data subchannel for a data message from the least-used subchannels. In some examples, the UE 115-b may select a feedback resource block based on the sensing window and randomly select a control resource block for a control message from the least used feedback resource blocks. In some examples, a sensing window size may be smaller for unicast communication, as communication patterns for unicast signaling may be more localized and continuous than multicast signaling.

The UE 115-a may receive a data message on a data resource of the allocation pair and transmit a control message on a control resource of the allocation pair. The control message (e.g., a payload of the control message) may include control or feedback information, such as for one or more previously received data transmissions. In some examples, a payload of the control message may include a precoder matrix indication. The precoder matrix indication may be frequency selective or associated with a wideband. In some examples, the control information may include acknowledgement feedback, such as HARQ feedback. In some examples, the HARQ feedback may correspond to a previously received data message. In some cases, channel coding may be used for small payload sizes. Channel coding may enable lower power transmission, which may assist self-interference suppression for full duplex operation. In some examples, the UE 115-a may apply channel coding to the control message. Additionally, or alternatively, the UE 115-a may include channel coding information in the control message.

In some examples, the UE 115-a may determine feedback for the control message based on pilot signals. For example, the UE 115-a may determine the feedback based on 4-port CSI-RS. Additionally, or alternatively, 2-port CSI-RS with a known precoding may be used to determine 2 port channel estimation and calculate the feedback from the 4-element codebook based on co-phasing. In some examples, precoding adaptation may be used for contiguous transmission in a same direction (e.g., from the UE 115-b to the UE 115-a). For supporting, two-way communication, channel reciprocity may be used such that each UE 115 may calculate a precoding matrix to use for transmission from the received pilots from a last receive slot. Continuous feedback may support adaptation of PMI one or more times per slot. In some examples, PMI may be updated or adapted multiple times per slot based on processing times of the UEs 115 and availability of CI-RS embedded symbols.

FIG. 3 illustrates an example of a resource allocation scheme 300, a resource allocation scheme 301, and a resource allocation scheme 302 that supports continuous control feedback using full duplex for cellular V2X communications in accordance with one or more aspects of the present disclosure. The resource allocation schemes may correspond to different rules or configurations for data and control resource allocation pairs.

A UE 115 may be scheduled a control resource and data resource pair to receive a data message while transmitting a control message in accordance with full duplex operation. For example, a UE 115 may be scheduled for data subchannel 0, which may correspond to or be paired with control subchannel 0. The UE 115 may receive a data message via data subchannel 0 and, concurrently, transmit a control message via control subchannel 0.

These resource allocation schemes may be configured to provide a gap in frequency between a data subchannel and a corresponding control subchannel. By configuring the resource allocation schemes to have a gap in frequency between control and data resource pairs, the UE 115 may transmit the control message with mitigated self-interference to reception of the data message.

The resource allocation scheme 300 may be an example of using spare or residual resource blocks of a sidelink channel for continuous feedback. In some cases, the resource allocation scheme 300 may be used for a 40 MHz sidelink channel with 30 kHz subcarrier spacing with 106 resource blocks spanning the frequency domain. The sidelink channel may include 10 subchannels, each subchannel spanning 10 resource blocks. Therefore, the channel may include 6 resource blocks which are not included in any of the 10 subchannels.

For example, a data allocation 305-a may include the 10 subchannels allocated for data signaling. A control allocation 310-a may correspond to five of the resource blocks which are not included in any of the subchannels for data signaling. In some examples, the data allocation 305-a and the control allocation 310-a may be separated by a gap 315-a in frequency, which may correspond to one resource block which is not included in any of the data subchannels. In some examples, the control allocation 310-a may include 10 subchannels, each spanning one resource block. In some examples, the minimal gap in frequency between a data subchannel and a control resource block may be 6 resource blocks, between data subchannel 9 and control resource block 9.

In some examples of the resource allocation scheme 300, the control resource blocks may be multiplexed together by using different cyclic shifts. For example, control resource block 0 and control resource block 1 may correspond to a same frequency, but a UE 115 may apply a first cyclic shift 320-a to use the control resource block 1 or a second cyclic shift 320-b to use the control resource block 0. In this example, the pairing may be fixed or preconfigured per resource pool or dynamically indicated via sidelink control information.

Additionally, or alternatively, the control resource blocks 0, 2, 4, 6, and 8 in the resource allocation scheme 300 may be used by UEs 115 which do not support full duplex operation. In this example, control resource blocks 1, 3, 5, 7, and 9 may be used by UEs 115 which do support full duplex operation, and these UEs 115 may not use different cyclic shifts for the control resource blocks. In this example, the pairing may be dynamic and indicated via sidelink control information.

The resource allocation scheme 301 may illustrate an example of using one resource block in each subchannel for control signaling. In some cases, the resource allocation scheme 301 may be used for a 40 MHz sidelink channel with 30 kHz subcarrier spacing with 106 resource blocks spanning the frequency domain. The sidelink channel may include 10 subchannels, each subchannel spanning 10 resource blocks. Therefore, the channel may include 6 resource blocks which are not included in any of the 10 subchannels. For example, a data allocation 305-b may include the 10 subchannels allocated for data signaling, but one resource block of each subchannel may be allocated as a control allocation 310-b. In some examples, any remaining resource blocks which are not included in a subchannel may correspond to a gap 315-b from other channels.

For example, a first resource block of each subchannel may be included in the control allocation 310-b, and the remaining nine resource blocks of each subchannel may be included in the data allocation 305-b. In some cases, a UE 115 may apply a different sidelink shared channel and sidelink control channel multiplexing mapping rule when a first resource block of a subchannel is used for control signaling.

In some examples, a minimum gap between a data resource and a control resource of a pair in the resource allocation scheme 301 may be 50 resource blocks. For example, data resource 5 may be paired with control resource that is in a subchannel with data resource 0.

In some examples, a last resource block in each subchannel for the resource allocation scheme 301 may be allocated as the control allocation 310-b. In this example, since the last resource block of a subchannel is not overlapping with a sidelink control channel of the subchannel, signaling on the sidelink control channel and a sidelink shared channel of the subchannel may be transmitted without different multiplexing mapping. In this example, the last resource block may be affected by interference, but the interference may be mitigated by applying a modulation and coding scheme to mitigate the interference.

The resource allocation scheme 302 may illustrate an example of using spare resource blocks and one subchannel for a control allocation 310-c. In some cases, the resource allocation scheme 302 may be used for a 40 MHz sidelink channel with 30 kHz subcarrier spacing with 106 resource blocks spanning the frequency domain. The sidelink channel may include 10 subchannels, each subchannel spanning 10 resource blocks. Therefore, the channel may include 6 resource blocks which are not included in any of the 10 subchannels. In the example of the resource allocation scheme 302, a first subchannel of the channel and some resource blocks not included in a subchannel may be allocated as a control allocation 310-c. A remaining nine subchannels of the channel may be allocated as a data allocation 305-c. For example, a first subchannel of the channel may be used for full-duplex control feedback. In some cases, a minimum gap between a data resource and a control resource of a pair may be 50 resource blocks. In some examples, some remaining resource blocks which are not included in the data allocation 305-c or the control allocation 310-c may be used as a gap 315-c between the data allocation 305-c and the control allocation 310-c.

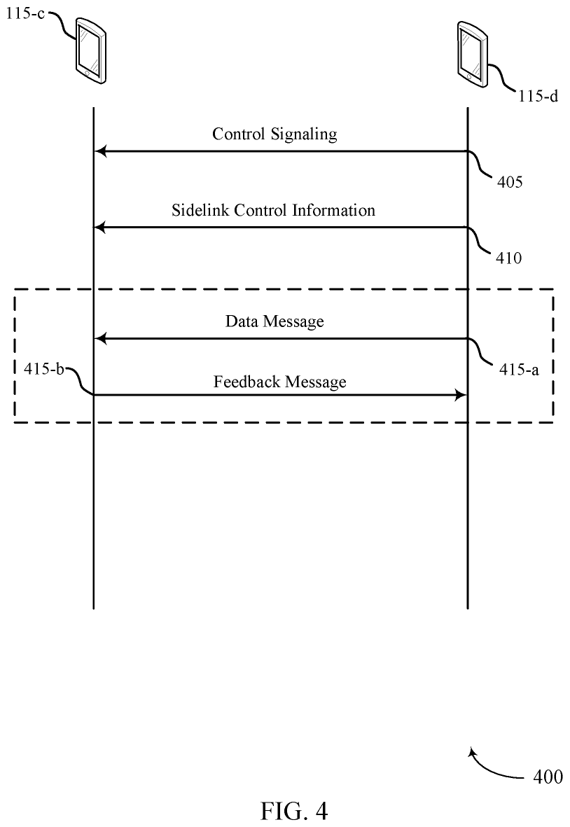

FIG. 4 illustrates an example of a process flow 400 that supports continuous control feedback using full duplex for cellular V2X communications in accordance with one or more aspects of the present disclosure. The process flow 400 may be implemented by a UE 115-c or a UE 115-d, or both, which may each be an example of a UE 115 as described with reference to FIGS. 1 and 2. In some examples, some processes or signaling of the process flow 400 may occur in a different order than shown.

Additionally, or alternatively, some processes or signaling shown in the process flow 400 may not occur, or some additional processes or signaling not shown may occur, or both.

In some examples, at 405, the UE 115-c may receive control signaling indicating an association between resource blocks of a first resource pool for data messages and resource blocks of a second resource pool for feedback messages. For example, the UE 115-c may receive the control signaling configuring control and data resource pairs for continuous feedback using full duplex operation. The UE 115-c may receive the control signaling from the UE 115-d or another device, such as a network entity 105.

At 410, the UE 115-c may receive sidelink control information from the UE 115-d. For example, the UE 115-c may receive, via a sidelink, a control signal indicating a first set of resource blocks of a channel in a slot for a data message from the UE 115-d.

In some examples, the sidelink control information may include a first indication of a first set of resource blocks from the first pool of resources and a second indication of a second set of resource blocks from the second resource pool. In some examples, the sidelink control information may include an indication of the first set of resource blocks from the first resource pool, and the second set of resource blocks may be identified based on a correspondence between the first set of resource blocks and the second set of resource blocks. For example, the sidelink control information may indicate a data resource of a resource pair or a control resource of the resource pair, or both. For example, the UE 115-c may receive the control signaling at 405 configuring fixed control and data resource pools and pairings, and the sidelink control information may indicate a data resource or a control resource, or both, from the resource pools.

Additionally, or alternatively, the data resource selection or control resource selection, or both, may be dynamically determined and indicated via the sidelink control information.

At 415, the UE 115-c may transmit a control message and receive a data message in accordance with a full duplex operation. For example, at 415-a, the UE 115-c may receive, from the UE 115-d via the sidelink, the data message over the first set of resource blocks in the slot based on the control signaling. At 415-b, the UE 115-c may transmit, to the UE 115-d via the sidelink, a feedback message over a second set of resource blocks of the channel in the slot. For example, the UE 115-c may transmit the feedback message concurrent with receiving the data message. In some cases, the second set of resource blocks is multiplexed, according to a cyclic shift, on a same set of time-frequency resources with a third set of resource blocks for feedback message transmitted by the UE 115-c or another UE 115.

The second set of resource blocks of the channel for feedback message may correspond to data message received over the first set of resource blocks of the channel. For example, the first set of resource blocks and the second set of resource blocks may be an example of a control and data resource pair.

In some examples, the second set of resource blocks may be separated from the first set of resource blocks in frequency by one or more resource blocks. For example, a control resource block may be separated from a corresponding data subchannel by a quantity (e.g., a minimum quantity) of resource blocks, which may assist the UE 115-c in receiving the data message without self-interference from transmitting the feedback message.

The feedback message, or the control message, may include feedback information or control information, or both. In some examples, the feedback message may include a precoding matrix indicator, acknowledgment feedback, channel coding information, or any combination thereof. In some examples, the UE 115-d may update a precoder for transmission to the UE 115-c based on the feedback message. In some examples, the UE 115-d may transmit the feedback message using an extended cyclic prefix for the feedback message (e.g., to prevent self-interference with reception of the data message).

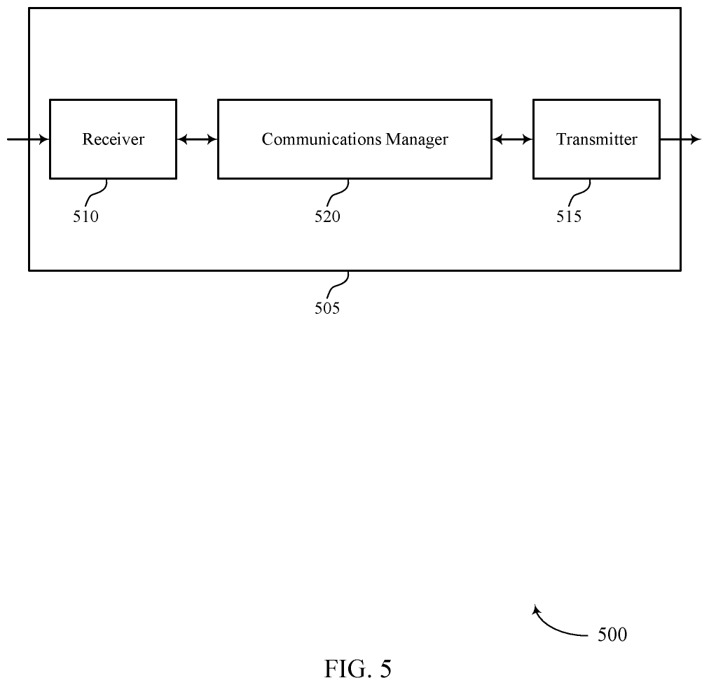

FIG. 5 shows a block diagram 500 of a device 505 that supports continuous control feedback using full duplex for cellular V2X communications in accordance with one or more aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to continuous control feedback using full duplex for cellular V2X communications). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to continuous control feedback using full duplex for cellular V2X communications). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of continuous control feedback using full duplex for cellular V2X communications as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications at a first UE in accordance with examples as disclosed herein. For example, the communications manager 520 may be configured as or otherwise support a means for receiving, via a sidelink, a control signal indicating a first set of resource blocks of a channel in a slot for a data message from a second UE. The communications manager 520 may be configured as or otherwise support a means for receiving, from the second UE via the sidelink, the data message over the first set of resource blocks in the slot based on the control signal. The communications manager 520 may be configured as or otherwise support a means for transmitting, to the second UE via the sidelink, a feedback message over a second set of resource blocks of the channel in the slot, the second set of resource blocks of the channel for feedback messages corresponding to data messages received over the first set of resource blocks of the channel, and the second set of resource blocks separated from the first set of resource blocks in frequency by one or more resource blocks.

Additionally, or alternatively, the communications manager 520 may support wireless communications at a second UE in accordance with examples as disclosed herein. For example, the communications manager 520 may be configured as or otherwise support a means for transmitting, to a first UE via a sidelink, a control signal indicating a first set of resource blocks of a channel in a slot for a data message to the first UE. The communications manager 520 may be configured as or otherwise support a means for transmitting, to the first UE via the sidelink, the data message over the first set of resource blocks in the slot based on the control signal. The communications manager 520 may be configured as or otherwise support a means for receiving, from the first UE via the sidelink, a feedback message over a second set of resource blocks of the channel in the slot, the second set of resource blocks of the channel for feedback messages corresponding to data messages transmitted over the first set of resource blocks of the channel, and the second set of resource blocks separated from the first set of resource blocks in frequency by one or more resource blocks.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for fast feedback in a V2X system, which may enable precoding for UEs 115 in the V2X system. Precoding may provide enhanced gain and channel capacity for sidelink signaling. Additionally, these techniques may improve reliability by reducing collisions on a sidelink channel and reducing latency based on feedback latency reduction using concurrent feedback transmission.

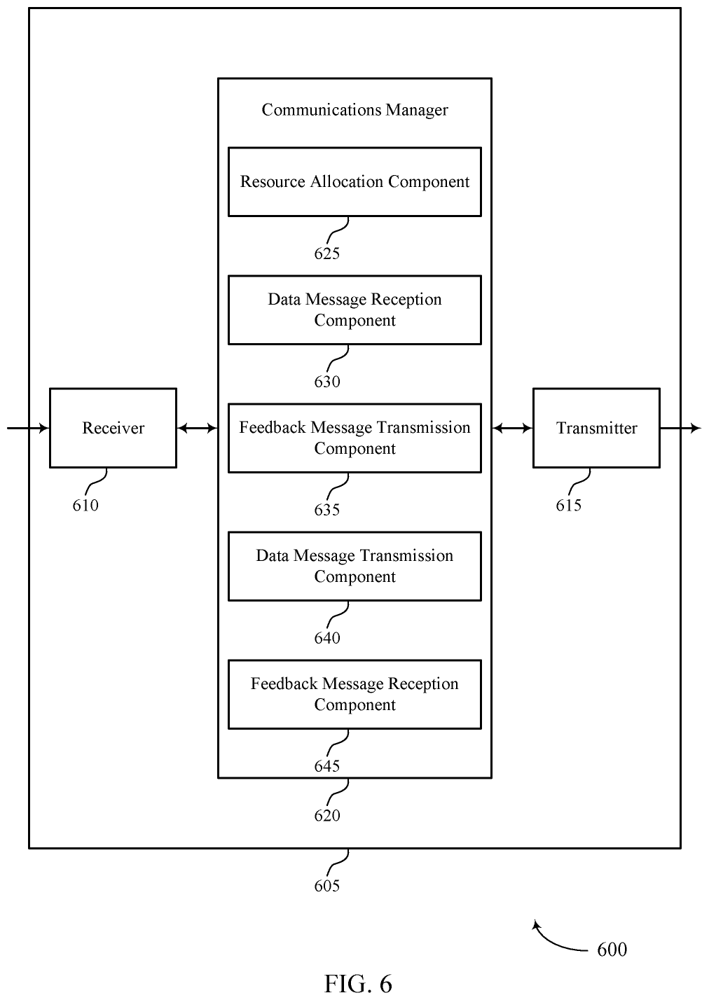

FIG. 6 shows a block diagram 600 of a device 605 that supports continuous control feedback using full duplex for cellular V2X communications in accordance with one or more aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to continuous control feedback using full duplex for cellular V2X communications). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to continuous control feedback using full duplex for cellular V2X communications). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of continuous control feedback using full duplex for cellular V2X communications as described herein. For example, the communications manager 620 may include a resource allocation component 625, a data message reception component 630, a feedback message transmission component 635, a data message transmission component 640, a feedback message reception component 645, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a first UE in accordance with examples as disclosed herein. The resource allocation component 625 may be configured as or otherwise support a means for receiving, via a sidelink, a control signal indicating a first set of resource blocks of a channel in a slot for a data message from a second UE. The data message reception component 630 may be configured as or otherwise support a means for receiving, from the second UE via the sidelink, the data message over the first set of resource blocks in the slot based on the control signal. The feedback message transmission component 635 may be configured as or otherwise support a means for transmitting, to the second UE via the sidelink, a feedback message over a second set of resource blocks of the channel in the slot, the second set of resource blocks of the channel for feedback messages corresponding to data messages received over the first set of resource blocks of the channel, and the second set of resource blocks separated from the first set of resource blocks in frequency by one or more resource blocks.

Additionally, or alternatively, the communications manager 620 may support wireless communications at a second UE in accordance with examples as disclosed herein. The resource allocation component 625 may be configured as or otherwise support a means for transmitting, to a first UE via a sidelink, a control signal indicating a first set of resource blocks of a channel in a slot for a data message to the first UE. The data message transmission component 640 may be configured as or otherwise support a means for transmitting, to the first UE via the sidelink, the data message over the first set of resource blocks in the slot based on the control signal. The feedback message reception component 645 may be configured as or otherwise support a means for receiving, from the first UE via the sidelink, a feedback message over a second set of resource blocks of the channel in the slot, the second set of resource blocks of the channel for feedback messages corresponding to data messages transmitted over the first set of resource blocks of the channel, and the second set of resource blocks separated from the first set of resource blocks in frequency by one or more resource blocks.

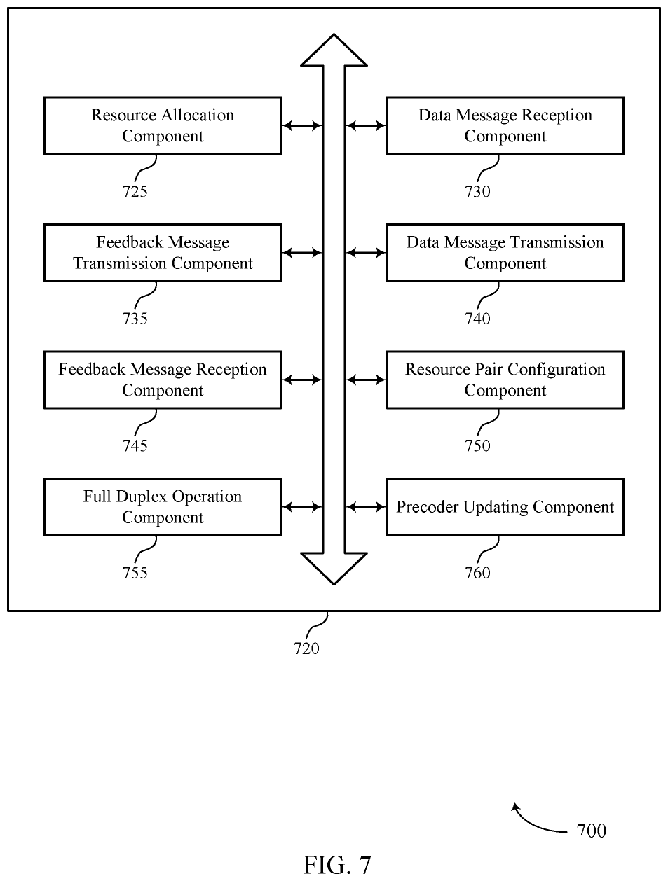

FIG. 7 shows a block diagram 700 of a communications manager 720 that supports continuous control feedback using full duplex for cellular V2X communications in accordance with one or more aspects of the present disclosure. The communications manager 720 may be an example of aspects of a communications manager 520, a communications manager 620, or both, as described herein. The communications manager 720, or various components thereof, may be an example of means for performing various aspects of continuous control feedback using full duplex for cellular V2X communications as described herein. For example, the communications manager 720 may include a resource allocation component 725, a data message reception component 730, a feedback message transmission component 735, a data message transmission component 740, a feedback message reception component 745, a resource pair configuration component 750, a full duplex operation component 755, a precoder updating component 760, or any combination thereof. Each of these components may communicate, directly or indirectly, with one another (e.g., via one or more buses).

The communications manager 720 may support wireless communications at a first UE in accordance with examples as disclosed herein. The resource allocation component 725 may be configured as or otherwise support a means for receiving, via a sidelink, a control signal indicating a first set of resource blocks of a channel in a slot for a data message from a second UE. The data message reception component 730 may be configured as or otherwise support a means for receiving, from the second UE via the sidelink, the data message over the first set of resource blocks in the slot based on the control signal. The feedback message transmission component 735 may be configured as or otherwise support a means for transmitting, to the second UE via the sidelink, a feedback message over a second set of resource blocks of the channel in the slot, the second set of resource blocks of the channel for feedback messages corresponding to data messages received over the first set of resource blocks of the channel, and the second set of resource blocks separated from the first set of resource blocks in frequency by one or more resource blocks.

In some examples, the resource pair configuration component 750 may be configured as or otherwise support a means for receiving control signaling indicating an association between resource blocks of a first pool of resources for the data messages and resource blocks of a second pool of resources for the feedback messages.

In some examples, to support receiving the control signal, the resource pair configuration component 750 may be configured as or otherwise support a means for receiving a first indication of the first set of resource blocks from the first pool of resources and a second indication of the second set of resource blocks from the second pool of resources.

In some examples, to support receiving the control signal, the resource pair configuration component 750 may be configured as or otherwise support a means for receiving an indication of the first set of resource blocks from the first pool of resources, where the second set of resource blocks are identified based on a correspondence between the first set of resource blocks and the second set of resource blocks.

In some examples, to support receiving the control signal, the resource allocation component 725 may be configured as or otherwise support a means for receiving an indication of the second set of resource blocks of the channel for transmission of the feedback message.

In some examples, the second set of resource blocks is based on a resource occupancy of the channel.

In some examples, to support transmitting the feedback message, the full duplex operation component 755 may be configured as or otherwise support a means for transmitting the feedback message concurrent with receiving the data message.

In some examples, to support transmitting the feedback message, the full duplex operation component 755 may be configured as or otherwise support a means for transmitting the feedback message using an extended cyclic prefix for the feedback message.

In some examples, to support transmitting the feedback message, the feedback message transmission component 735 may be configured as or otherwise support a means for transmitting a precoding matrix indicator, acknowledgement feedback, an extended cyclic prefix, channel coding information, or any combination thereof.

In some examples, the second set of resource blocks is multiplexed, according to a cyclic shift, on a same set of time-frequency resources with a third set of resource blocks for feedback messages transmitted by the second UE or a third UE.

In some examples, to support transmitting the feedback message, the feedback message transmission component 735 may be configured as or otherwise support a means for transmitting the feedback message indicating feedback for a data message received from the second UE in a previous slot.

In some examples, the first set of resource blocks is one of a first set of multiple sets of resource blocks for a group of UEs in a first portion of the channel in the slot, and the second set of resource blocks is one of a second set of multiple sets of resource blocks for the group of UEs in a corresponding second portion of the channel in the slot.

In some examples, the first set of resource blocks is one of a first set of multiple sets of resource blocks for a group of UEs in the channel in the slot, and the second set of resource blocks is one of a second set of multiple sets of resource blocks for the group of UEs in the channel in the slot. In some examples, sets of resource blocks of the second set of multiple sets of resource blocks are interleaved with sets of resource blocks of the first set of multiple sets of resource blocks.

In some examples, the first set of resource blocks is one of a first set of multiple sets of resource blocks for a group of UEs in the channel in the slot, and the second set of resource blocks is one of a second set of multiple sets of resource blocks for the group of UEs in the channel in the slot. In some examples, a first portion of sets of resource blocks of the second set of multiple sets of resource blocks are adjacent a first edge of the channel, and a second portion of sets of resource blocks of the second set of multiple sets of resource blocks are adjacent a second edge of the channel.

In some examples, the channel is a radio frequency spectrum band for V2X communications.

Additionally, or alternatively, the communications manager 720 may support wireless communications at a second UE in accordance with examples as disclosed herein. In some examples, the resource allocation component 725 may be configured as or otherwise support a means for transmitting, to a first UE via a sidelink, a control signal indicating a first set of resource blocks of a channel in a slot for a data message to the first UE. The data message transmission component 740 may be configured as or otherwise support a means for transmitting, to the first UE via the sidelink, the data message over the first set of resource blocks in the slot based on the control signal. The feedback message reception component 745 may be configured as or otherwise support a means for receiving, from the first UE via the sidelink, a feedback message over a second set of resource blocks of the channel in the slot, the second set of resource blocks of the channel for feedback messages corresponding to data messages transmitted over the first set of resource blocks of the channel, and the second set of resource blocks separated from the first set of resource blocks in frequency by one or more resource blocks.

In some examples, the resource pair configuration component 750 may be configured as or otherwise support a means for receiving control signaling indicating an association between resource blocks of a first pool of resources for the data messages and resource blocks of a second pool of resources for the feedback messages.

In some examples, to support transmitting the control signal, the resource allocation component 725 may be configured as or otherwise support a means for transmitting a first indication of the first set of resource blocks from the first pool of resources and a second indication of the second set of resource blocks from the second pool of resources.

In some examples, to support transmitting the control signal, the resource allocation component 725 may be configured as or otherwise support a means for transmitting an indication of the first set of resource blocks from the first pool of resources, where the second set of resource blocks are identified based on a correspondence between the first set of resource blocks and the second set of resource blocks.

In some examples, to support transmitting the control signal, the resource allocation component 725 may be configured as or otherwise support a means for transmitting an indication of the second set of resource blocks of the channel for transmission of the feedback message.

In some examples, the second set of resource blocks is based on a resource occupancy of the channel.

In some examples, to support receiving the feedback message, the full duplex operation component 755 may be configured as or otherwise support a means for receiving the feedback message concurrent with transmitting the data message.

In some examples, to support receiving the feedback message, the feedback message reception component 745 may be configured as or otherwise support a means for receiving the feedback message including a precoding matrix indicator, acknowledgement feedback, an extended cyclic prefix, channel coding information, or any combination thereof.

In some examples, the second set of resource blocks is multiplexed, according to a cyclic shift, on a same set of time-frequency resources with a third set of resource blocks for feedback messages transmitted by the second UE or a third UE.

In some examples, to support receiving the feedback message, the feedback message reception component 745 may be configured as or otherwise support a means for receiving the feedback message indicating feedback for a data message transmitted to the first UE in a previous slot.

In some examples, the precoder updating component 760 may be configured as or otherwise support a means for updating a precoder for transmission to the first UE based on the feedback message.

In some examples, the first set of resource blocks is one of a first set of multiple sets of resource blocks for a group of UEs in a first portion of the channel in the slot, and the second set of resource blocks is one of a second set of multiple sets of resource blocks for the group of UEs in a corresponding second portion of the channel in the slot.

In some examples, the first set of resource blocks is one of a first set of multiple sets of resource blocks for a group of UEs in the channel in the slot, and the second set of resource blocks is one of a second set of multiple sets of resource blocks for the group of UEs in the channel in the slot. In some examples, sets of resource blocks of the second set of multiple sets of resource blocks are interleaved with sets of resource blocks of the first set of multiple sets of resource blocks.

In some examples, the first set of resource blocks is one of a first set of multiple sets of resource blocks for a group of UEs in the channel in the slot, and the second set of resource blocks is one of a second set of multiple sets of resource blocks for the group of UEs in the channel in the slot. In some examples, a first portion of sets of resource blocks of the second set of multiple sets of resource blocks are adjacent a first edge of the channel, and a second portion of sets of resource blocks of the second set of multiple sets of resource blocks are adjacent a second edge of the channel.

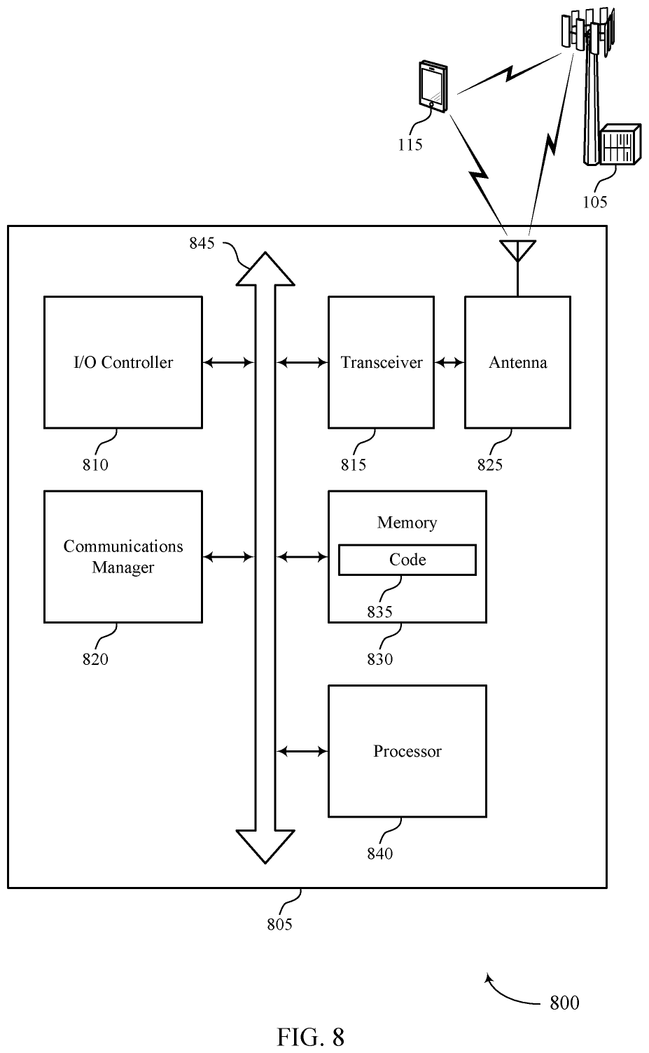

FIG. 8 shows a diagram of a system 800 including a device 805 that supports continuous control feedback using full duplex for cellular V2X communications in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting continuous control feedback using full duplex for cellular V2X communications). For example, the device 805 or a component of the device 805 may include a processor 840 and memory 830 coupled with or to the processor 840, the processor 840 and memory 830 configured to perform various functions described herein.

The communications manager 820 may support wireless communications at a first UE in accordance with examples as disclosed herein. For example, the communications manager 820 may be configured as or otherwise support a means for receiving, via a sidelink, a control signal indicating a first set of resource blocks of a channel in a slot for a data message from a second UE. The communications manager 820 may be configured as or otherwise support a means for receiving, from the second UE via the sidelink, the data message over the first set of resource blocks in the slot based on the control signal. The communications manager 820 may be configured as or otherwise support a means for transmitting, to the second UE via the sidelink, a feedback message over a second set of resource blocks of the channel in the slot, the second set of resource blocks of the channel for feedback messages corresponding to data messages received over the first set of resource blocks of the channel, and the second set of resource blocks separated from the first set of resource blocks in frequency by one or more resource blocks.

Additionally, or alternatively, the communications manager 820 may support wireless communications at a second UE in accordance with examples as disclosed herein. For example, the communications manager 820 may be configured as or otherwise support a means for transmitting, to a first UE via a sidelink, a control signal indicating a first set of resource blocks of a channel in a slot for a data message to the first UE. The communications manager 820 may be configured as or otherwise support a means for transmitting, to the first UE via the sidelink, the data message over the first set of resource blocks in the slot based on the control signal. The communications manager 820 may be configured as or otherwise support a means for receiving, from the first UE via the sidelink, a feedback message over a second set of resource blocks of the channel in the slot, the second set of resource blocks of the channel for feedback messages corresponding to data messages transmitted over the first set of resource blocks of the channel, and the second set of resource blocks separated from the first set of resource blocks in frequency by one or more resource blocks.

By including or configuring the communications manager 820 in accordance with examples as described herein, the device 805 may support techniques for fast feedback in a V2X system, which may enable precoding for UEs 115 in the V2X system. Precoding may provide enhanced gain and channel capacity for sidelink signaling. Additionally, these techniques may improve reliability by reducing collisions on a sidelink channel and reducing latency based on feedback latency reduction using concurrent feedback transmission.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of continuous control feedback using full duplex for cellular V2X communications as described herein, or the processor 840 and the memory 830 may be otherwise configured to perform or support such operations.

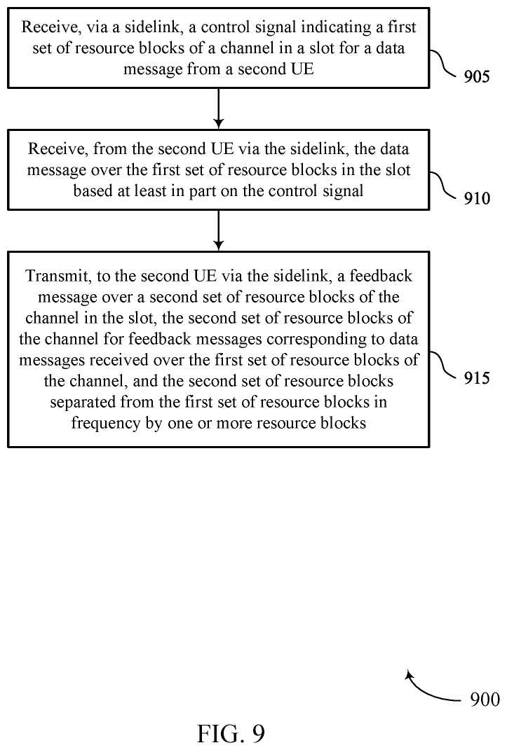

FIG. 9 shows a flowchart illustrating a method 900 that supports continuous control feedback using full duplex for cellular V2X communications in accordance with one or more aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 905, the method may include receiving, via a sidelink, a control signal indicating a first set of resource blocks of a channel in a slot for a data message from a second UE. The operations of 905 may be performed in accordance with examples as disclosed herein. In some examples, aspects of the operations of 905 may be performed by a resource allocation component 725 as described with reference to FIG. 7.

At 910, the method may include receiving, from the second UE via the sidelink, the data message over the first set of resource blocks in the slot based on the control signal. The operations of 910 may be performed in accordance with examples as disclosed herein. In some examples, aspects of the operations of 910 may be performed by a data message reception component 730 as described with reference to FIG. 7.

At 915, the method may include transmitting, to the second UE via the sidelink, a feedback message over a second set of resource blocks of the channel in the slot, the second set of resource blocks of the channel for feedback messages corresponding to data messages received over the first set of resource blocks of the channel, and the second set of resource blocks separated from the first set of resource blocks in frequency by one or more resource blocks. The operations of 915 may be performed in accordance with examples as disclosed herein. In some examples, aspects of the operations of 915 may be performed by a feedback message transmission component 735 as described with reference to FIG. 7.

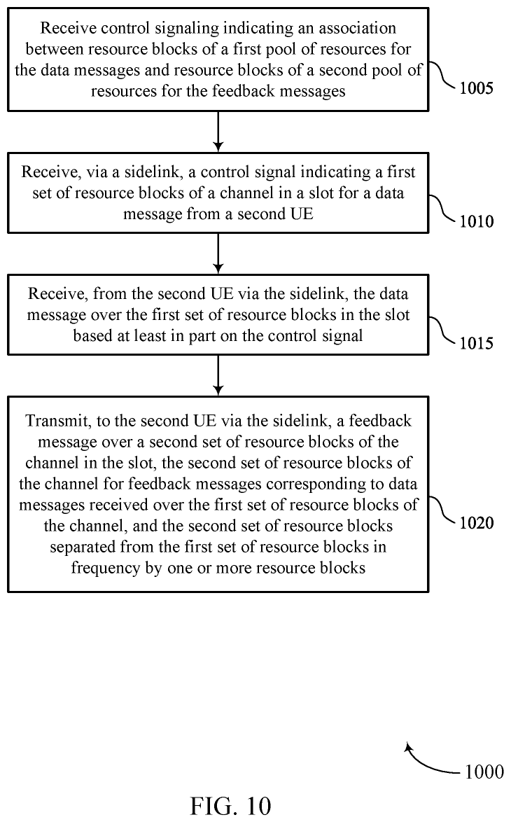

FIG. 10 shows a flowchart illustrating a method 1000 that supports continuous control feedback using full duplex for cellular V2X communications in accordance with one or more aspects of the present disclosure. The operations of the method 1000 may be implemented by a UE or its components as described herein. For example, the operations of the method 1000 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1005, the method may include receiving control signaling indicating an association between resource blocks of a first pool of resources for the data messages and resource blocks of a second pool of resources for the feedback messages. The operations of 1005 may be performed in accordance with examples as disclosed herein. In some examples, aspects of the operations of 1005 may be performed by a resource pair configuration component 750 as described with reference to FIG. 7.

At 1010, the method may include receiving, via a sidelink, a control signal indicating a first set of resource blocks of a channel in a slot for a data message from a second UE. The operations of 1010 may be performed in accordance with examples as disclosed herein. In some examples, aspects of the operations of 1010 may be performed by a resource allocation component 725 as described with reference to FIG. 7.

At 1015, the method may include receiving, from the second UE via the sidelink, the data message over the first set of resource blocks in the slot based on the control signal. The operations of 1015 may be performed in accordance with examples as disclosed herein. In some examples, aspects of the operations of 1015 may be performed by a data message reception component 730 as described with reference to FIG. 7.

At 1020, the method may include transmitting, to the second UE via the sidelink, a feedback message over a second set of resource blocks of the channel in the slot, the second set of resource blocks of the channel for feedback messages corresponding to data messages received over the first set of resource blocks of the channel, and the second set of resource blocks separated from the first set of resource blocks in frequency by one or more resource blocks. The operations of 1020 may be performed in accordance with examples as disclosed herein. In some examples, aspects of the operations of 1020 may be performed by a feedback message transmission component 735 as described with reference to FIG. 7.

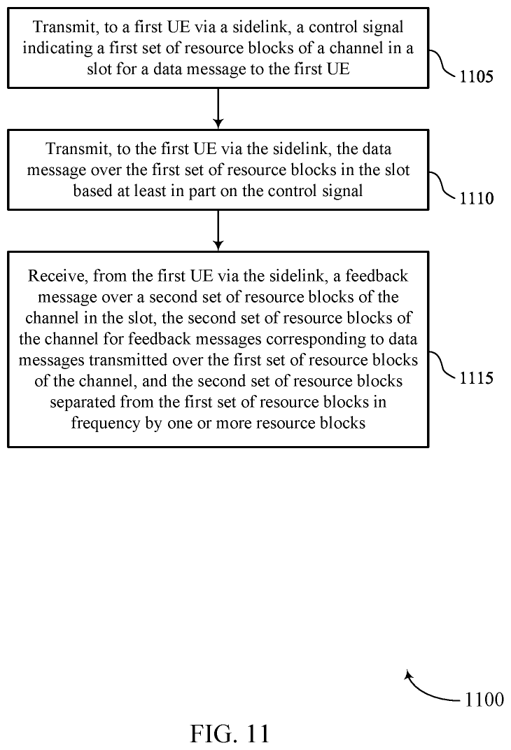

FIG. 11 shows a flowchart illustrating a method 1100 that supports continuous control feedback using full duplex for cellular V2X communications in accordance with one or more aspects of the present disclosure. The operations of the method 1100 may be implemented by a UE or its components as described herein. For example, the operations of the method 1100 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1105, the method may include transmitting, to a first UE via a sidelink, a control signal indicating a first set of resource blocks of a channel in a slot for a data message to the first UE. The operations of 1105 may be performed in accordance with examples as disclosed herein. In some examples, aspects of the operations of 1105 may be performed by a resource allocation component 725 as described with reference to FIG. 7.

At 1110, the method may include transmitting, to the first UE via the sidelink, the data message over the first set of resource blocks in the slot based on the control signal. The operations of 1110 may be performed in accordance with examples as disclosed herein. In some examples, aspects of the operations of 1110 may be performed by a data message transmission component 740 as described with reference to FIG. 7.

At 1115, the method may include receiving, from the first UE via the sidelink, a feedback message over a second set of resource blocks of the channel in the slot, the second set of resource blocks of the channel for feedback messages corresponding to data messages transmitted over the first set of resource blocks of the channel, and the second set of resource blocks separated from the first set of resource blocks in frequency by one or more resource blocks. The operations of 1115 may be performed in accordance with examples as disclosed herein. In some examples, aspects of the operations of 1115 may be performed by a feedback message reception component 745 as described with reference to FIG. 7.

The following provides an overview of aspects of the present disclosure:

Aspect 1: A method for wireless communications at a first UE, comprising: receiving, via a sidelink, a control signal indicating a first set of resource blocks of a channel in a slot for a data message from a second UE; receiving, from the second UE via the sidelink, the data message over the first set of resource blocks in the slot based at least in part on the control signal; and transmitting, to the second UE via the sidelink, a feedback message over a second set of resource blocks of the channel in the slot, the second set of resource blocks of the channel for feedback messages corresponding to data messages received over the first set of resource blocks of the channel, and the second set of resource blocks separated from the first set of resource blocks in frequency by one or more resource blocks.

Aspect 2: The method of aspect 1, further comprising: receiving control signaling indicating an association between resource blocks of a first pool of resources for the data messages and resource blocks of a second pool of resources for the feedback messages.

Aspect 3: The method of aspect 2, wherein receiving the control signal comprises: receiving a first indication of the first set of resource blocks from the first pool of resources and a second indication of the second set of resource blocks from the second pool of resources.

Aspect 4: The method of any of aspects 2 through 3, wherein receiving the control signal comprises: receiving an indication of the first set of resource blocks from the first pool of resources, wherein the second set of resource blocks are identified based at least in part on a correspondence between the first set of resource blocks and the second set of resource blocks.

Aspect 5: The method of any of aspects 1 through 4, wherein receiving the control signal comprises: receiving an indication of the second set of resource blocks of the channel for transmission of the feedback message.

Aspect 6: The method of aspect 5, wherein the second set of resource blocks is based at least in part on a resource occupancy of the channel.

Aspect 7: The method of any of aspects 1 through 6, wherein transmitting the feedback message comprises: transmitting the feedback message concurrent with receiving the data message.

Aspect 8: The method of any of aspects 1 through 7, wherein transmitting the feedback message comprises: transmitting a precoding matrix indicator, acknowledgement feedback, channel coding information, or any combination thereof.

Aspect 9: The method of any of aspects 1 through 8, wherein transmitting the feedback message comprises: transmit the feedback message using an extended cyclic prefix for the feedback message.

Aspect 10: The method of any of aspects 1 through 9, wherein the second set of resource blocks is multiplexed, according to a cyclic shift, on a same set of time-frequency resources with a third set of resource blocks for feedback messages transmitted by the second UE or a third UE.

Aspect 11: The method of any of aspects 1 through 10, wherein transmitting the feedback message comprises: transmitting the feedback message indicating feedback for a data message received from the second UE in a previous slot.

Aspect 12: The method of any of aspects 1 through 11, wherein the first set of resource blocks is one of a first plurality of sets of resource blocks for a group of UEs in a first portion of the channel in the slot, and the second set of resource blocks is one of a second plurality of sets of resource blocks for the group of UEs in a corresponding second portion of the channel in the slot.

Aspect 13: The method of any of aspects 1 through 12, wherein the first set of resource blocks is one of a first plurality of sets of resource blocks for a group of UEs in the channel in the slot, and the second set of resource blocks is one of a second plurality of sets of resource blocks for the group of UEs in the channel in the slot, sets of resource blocks of the second plurality of sets of resource blocks are interleaved with sets of resource blocks of the first plurality of sets of resource blocks.

Aspect 14: The method of any of aspects 1 through 13, wherein the first set of resource blocks is one of a first plurality of sets of resource blocks for a group of UEs in the channel in the slot, and the second set of resource blocks is one of a second plurality of sets of resource blocks for the group of UEs in the channel in the slot, a first portion of sets of resource blocks of the second plurality of sets of resource blocks are adjacent a first edge of the channel, and a second portion of sets of resource blocks of the second plurality of sets of resource blocks are adjacent a second edge of the channel.

Aspect 15: The method of any of aspects 1 through 14, wherein the channel is a radio frequency spectrum band for vehicle-to-everything (V2X) communications.

Aspect 16: A method for wireless communications at a second UE, comprising: transmitting, to a first UE via a sidelink, a control signal indicating a first set of resource blocks of a channel in a slot for a data message to the first UE; transmitting, to the first UE via the sidelink, the data message over the first set of resource blocks in the slot based at least in part on the control signal; and receiving, from the first UE via the sidelink, a feedback message over a second set of resource blocks of the channel in the slot, the second set of resource blocks of the channel for feedback messages corresponding to data messages transmitted over the first set of resource blocks of the channel, and the second set of resource blocks separated from the first set of resource blocks in frequency by one or more resource blocks.

Aspect 17: The method of aspect 16, further comprising: receiving control signaling indicating an association between resource blocks of a first pool of resources for the data messages and resource blocks of a second pool of resources for the feedback messages.

Aspect 18: The method of aspect 17, wherein transmitting the control signal comprises: transmitting a first indication of the first set of resource blocks from the first pool of resources and a second indication of the second set of resource blocks from the second pool of resources.

Aspect 19: The method of any of aspects 17 through 18, wherein transmitting the control signal comprises: transmitting an indication of the first set of resource blocks from the first pool of resources, wherein the second set of resource blocks are identified based at least in part on a correspondence between the first set of resource blocks and the second set of resource blocks.

Aspect 20: The method of any of aspects 16 through 19, wherein transmitting the control signal comprises: transmitting an indication of the second set of resource blocks of the channel for transmission of the feedback message.

Aspect 21: The method of aspect 20, wherein the second set of resource blocks is based at least in part on a resource occupancy of the channel.

Aspect 22: The method of any of aspects 16 through 21, wherein receiving the feedback message comprises: receiving the feedback message concurrent with transmitting the data message.

Aspect 23: The method of any of aspects 16 through 22, wherein receiving the feedback message comprises: receiving the feedback message including a precoding matrix indicator, acknowledgement feedback, an extended cyclic prefix, channel coding information, or any combination thereof.

Aspect 24: The method of any of aspects 16 through 23, wherein the second set of resource blocks is multiplexed, according to a cyclic shift, on a same set of time-frequency resources with a third set of resource blocks for feedback messages transmitted by the second UE or a third UE.

Aspect 25: The method of any of aspects 16 through 24, wherein receiving the feedback message comprises: receiving the feedback message indicating feedback for a data message transmitted to the first UE in a previous slot.

Aspect 26: The method of any of aspects 16 through 25, further comprising: updating a precoder for transmission to the first UE based at least in part on the feedback message.

Aspect 27: The method of any of aspects 16 through 26, wherein the first set of resource blocks is one of a first plurality of sets of resource blocks for a group of UEs in a first portion of the channel in the slot, and the second set of resource blocks is one of a second plurality of sets of resource blocks for the group of UEs in a corresponding second portion of the channel in the slot.

Aspect 28: The method of any of aspects 16 through 27, wherein the first set of resource blocks is one of a first plurality of sets of resource blocks for a group of UEs in the channel in the slot, and the second set of resource blocks is one of a second plurality of sets of resource blocks for the group of UEs in the channel in the slot, sets of resource blocks of the second plurality of sets of resource blocks are interleaved with sets of resource blocks of the first plurality of sets of resource blocks.

Aspect 29: The method of any of aspects 16 through 28, wherein the first set of resource blocks is one of a first plurality of sets of resource blocks for a group of UEs in the channel in the slot, and the second set of resource blocks is one of a second plurality of sets of resource blocks for the group of UEs in the channel in the slot, a first portion of sets of resource blocks of the second plurality of sets of resource blocks are adjacent a first edge of the channel, and a second portion of sets of resource blocks of the second plurality of sets of resource blocks are adjacent a second edge of the channel.

Aspect 30: An apparatus for wireless communications at a first UE, comprising a processor; memory coupled with the processor; and instructions stored in the memory and executable by the processor to cause the apparatus to perform a method of any of aspects 1 through 15.

Aspect 31: An apparatus for wireless communications at a first UE, comprising at least one means for performing a method of any of aspects 1 through 15.

Aspect 32: A non-transitory computer-readable medium storing code for wireless communications at a first UE, the code comprising instructions executable by a processor to perform a method of any of aspects 1 through 15.

Aspect 33: An apparatus for wireless communications at a second UE, comprising a processor; memory coupled with the processor; and instructions stored in the memory and executable by the processor to cause the apparatus to perform a method of any of aspects 16 through 29.

Aspect 34: An apparatus for wireless communications at a second UE, comprising at least one means for performing a method of any of aspects 16 through 29.

Aspect 35: A non-transitory computer-readable medium storing code for wireless communications at a second UE, the code comprising instructions executable by a processor to perform a method of any of aspects 16 through 29.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communications at a first user equipment (UE), comprising:
a processor;
memory coupled with the processor; and
instructions stored in the memory and executable by the processor to cause the apparatus to:
receive, via a sidelink, a control signal indicating a first set of resource blocks of a channel in a slot for a data message from a second UE;
receive, from the second UE via the sidelink, the data message over the first set of resource blocks in the slot based at least in part on the control signal; and
transmit, to the second UE via the sidelink, a feedback message over a second set of resource blocks of the channel in the slot, the second set of resource blocks of the channel for feedback messages corresponding to data messages received over the first set of resource blocks of the channel, and the second set of resource blocks separated from the first set of resource blocks in frequency by one or more resource blocks.

2. The apparatus of claim 1, wherein the instructions are further executable by the processor to cause the apparatus to:
receive control signaling indicating an association between resource blocks of a first pool of resources for the data messages and resource blocks of a second pool of resources for the feedback messages.

3. The apparatus of claim 2, wherein the instructions to receive the control signal are executable by the processor to cause the apparatus to:
receive a first indication of the first set of resource blocks from the first pool of resources and a second indication of the second set of resource blocks from the second pool of resources.

4. The apparatus of claim 2, wherein the instructions to receive the control signal are executable by the processor to cause the apparatus to:
receive an indication of the first set of resource blocks from the first pool of resources, wherein the second set of resource blocks are identified based at least in part on a correspondence between the first set of resource blocks and the second set of resource blocks.

5. The apparatus of claim 1, wherein the instructions to receive the control signal are executable by the processor to cause the apparatus to:
receive an indication of the second set of resource blocks of the channel for transmission of the feedback message.

6. The apparatus of claim 5, wherein the second set of resource blocks is based at least in part on a resource occupancy of the channel.

7. The apparatus of claim 1, wherein the instructions to transmit the feedback message are executable by the processor to cause the apparatus to:
transmit the feedback message concurrent with receiving the data message.

8. The apparatus of claim 1, wherein the instructions to transmit the feedback message are executable by the processor to cause the apparatus to:
transmit a precoding matrix indicator, acknowledgement feedback, channel coding information, or any combination thereof.

9. The apparatus of claim 1, wherein the instructions to transmit the feedback message are executable by the processor to cause the apparatus to:
transmit the feedback message using an extended cyclic prefix for the feedback message.

10. The apparatus of claim 1, wherein the second set of resource blocks is multiplexed, according to a cyclic shift, on a same set of time-frequency resources with a third set of resource blocks for feedback messages transmitted by the second UE or a third UE.

11. The apparatus of claim 1, wherein the instructions to transmit the feedback message are executable by the processor to cause the apparatus to:
transmit the feedback message indicating feedback for a data message received from the second UE in a previous slot.

12. The apparatus of claim 1, wherein the first set of resource blocks is one of a first plurality of sets of resource blocks for a group of UEs in a first portion of the channel in the slot, and the second set of resource blocks is one of a second plurality of sets of resource blocks for the group of UEs in a corresponding second portion of the channel in the slot.

13. The apparatus of claim 1, wherein:
the first set of resource blocks is one of a first plurality of sets of resource blocks for a group of UEs in the channel in the slot, and the second set of resource blocks is one of a second plurality of sets of resource blocks for the group of UEs in the channel in the slot, wherein sets of resource blocks of the second plurality of sets of resource blocks are interleaved with sets of resource blocks of the first plurality of sets of resource blocks.

14. The apparatus of claim 1, wherein:
the first set of resource blocks is one of a first plurality of sets of resource blocks for a group of UEs in the channel in the slot, and the second set of resource blocks is one of a second plurality of sets of resource blocks for the group of UEs in the channel in the slot, wherein a first portion of sets of resource blocks of the second plurality of sets of resource blocks are adjacent a first edge of the channel, and a second portion of sets of resource blocks of the second plurality of sets of resource blocks are adjacent a second edge of the channel.

15. The apparatus of claim 1, wherein the channel is a radio frequency spectrum band for vehicle-to-everything (V2X) communications.

16. An apparatus for wireless communications at a second user equipment (UE), comprising:
a processor;
memory coupled with the processor; and
instructions stored in the memory and executable by the processor to cause the apparatus to:
transmit, to a first UE via a sidelink, a control signal indicating a first set of resource blocks of a channel in a slot for a data message to the first UE;
transmit, to the first UE via the sidelink, the data message over the first set of resource blocks in the slot based at least in part on the control signal; and
receive, from the first UE via the sidelink, a feedback message over a second set of resource blocks of the channel in the slot, the second set of resource blocks of the channel for feedback messages corresponding to data messages transmitted over the first set of resource blocks of the channel, and the second set of resource blocks separated from the first set of resource blocks in frequency by one or more resource blocks.

17. The apparatus of claim 16, wherein the instructions are further executable by the processor to cause the apparatus to:
receive control signaling indicating an association between resource blocks of a first pool of resources for the data messages and resource blocks of a second pool of resources for the feedback messages.

18. The apparatus of claim 17, wherein the instructions to transmit the control signal are executable by the processor to cause the apparatus to:
transmit a first indication of the first set of resource blocks from the first pool of resources and a second indication of the second set of resource blocks from the second pool of resources.

19. The apparatus of claim 17, wherein the instructions to transmit the control signal are executable by the processor to cause the apparatus to:
transmit an indication of the first set of resource blocks from the first pool of resources, wherein the second set of resource blocks are identified based at least in part on a correspondence between the first set of resource blocks and the second set of resource blocks.

20. The apparatus of claim 16, wherein the instructions to transmit the control signal are executable by the processor to cause the apparatus to:
transmit an indication of the second set of resource blocks of the channel for transmission of the feedback message.

21-30. (canceled)
